(19) United States
(12) Patent Application Publication
(10) Pub. No.: US 2011/0208418 A1
(43) Pub. Date: Aug. 25, 2011

(54) Completing Obligations Associated With Transactions Performed Via Mobile User Platforms Based on Digital Interactive Tickets

(76) Inventors: Erin C. Looney, Reno, NV (US); Scott C. Armstrong, Reno, NV (US)

(21) Appl. No.: 13/035,798

(22) Filed: Feb. 25, 2011

Related U.S. Application Data
(60) Provisional application No. 61/308,225, filed on Feb. 25, 2010.
(60) Provisional application No. 61/411,446, filed on Nov. 8, 2010.

(51) Int. Cl. G06Q 99/00; G06Q 30/00; G01C 21/00; G06F 15/16

(52) U.S. Cl. 701/200; 705/39; 709/217

(57) ABSTRACT

Completion of obligations associated with transactions performed via mobile user platforms may be facilitated based on digital interactive tickets associated with a unique geographical location and/or user preferences. An indication that a user has completed a transaction presented to the user via a user platform may be received. The transaction may have been completed responsive to content received at the user platform. The content may have been provided to the user platform based on a geographical location of the user platform and/or a user preference associated with the user. The content may include information associated with the geographical location of the user platform. A digital interactive ticket may be provided to the user platform responsive to receiving the indication. The digital interactive ticket may including executable software and/or requisite data enabling the digital interactive ticket to provide additional functionality on the user platform. The additional functionality may facilitate completion of one or more obligations associated with the completed transaction.

### CROSS-REFERENCE TO RELATED APPLICATIONS

The present application claims the priority benefit of U.S. provisional patent application Ser. No. 61/308,225 filed Feb. 25, 2010 and entitled “System and Method for Facilitating Transactions Over Mobile Platforms,” and U.S. provisional patent application Ser. No. 61/411,446 filed Nov. 8, 2010 and entitled “System and Method for Facilitating Transactions Over Mobile Platforms,” the disclosures of both are incorporated herein by reference.

### FIELD OF THE DISCLOSURE

This disclosure relates to facilitating completion of obligations associated with transactions performed via mobile user platforms based on digital interactive tickets associated with a unique geographical location and/or user preferences.

### BACKGROUND

Typically, completion of an obligation associated with a transaction, be it in-person or via the Internet, requires an individual to obtain and redeem a physical ticket or other proof that the transaction is complete. For on-the-go individuals, particularly, a physical ticket can be impossible, or at least quite inconvenient, to obtain.

### SUMMARY

One aspect of the invention relates to a system configured to facilitate completion of obligations associated with transactions performed via mobile user platforms based on digital interactive tickets associated with a unique geographical location and/or user preferences, in accordance with one or more implementations. The system may implement one or more features described herein. As depicted, the system may include at least one user platform, at least one vendor platform, at least one transaction server, one or more external resources, at least one central server, and/or other components, all being communicatively coupled to a network.

The user platform may be configured to receive content and communicate with the central server in connection with the content, setting up an account or indicating preferences for example. The communication may also result in the execution of a transaction provided to the user in the transaction data. The system may also be configured to facilitate communication between users, such as by providing text messaging applications or other applications which allow for data to be transferred wirelessly directly between user platforms.

The user platform may include one or more processors configured to execute computer program modules. The computer program modules may be configured to enable one or more users associated with the user platform to interface with the system, the vendor platform, the transaction server, the external resources, the central server, and/or other components, and/or provide other functionality attributed herein to the user platform. By way of non-limiting example, the user platform may include one or more of a desktop computer, a laptop computer, a handheld computer, a NetBook, a Smartphone, and/or other computing platforms. As such, the user platform may include one or more user interface devices. Examples of such user interface devices include a screen, a touch pad, a touch screen, a keyboard, a keypad, and/or other user interface devices suitable to facilitate interactions and/or information transfer between the user platform and a user.

In some implementations, the user platform may include one or more Thin Clients. The Thin Clients may include a software application that resides on the user platform, such as a user's Internet enabled device, which is responsible for portraying user interface, data display, interaction, and a limited amount of local storage (digital interactive tickets and so forth), or a web page/web browser interface that mimics the aforementioned functionality of the software application residing on the user platform but which can be accessed from any device with a web browser without the installation of user device-specific software.

One or more interfaces of system discussed herein may employ graphical user interfaces (GUIs) transmitted or downloaded to the user platform. The GUIs can incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons and other user interface controls. These features can be selected (i.e., “clicked on”) by the user via connected mouse, keyboard, voice command or other commonly used tool for indicating a preference, including a user-specified action, in a computerized graphical interface.

The external resources may include sources of information, hosts and/or providers of web sites and/or services outside of the system, external entities participating with the system, and/or other resources. In some implementations, the external resources may include social networking web sites, content providers, and/or other resources. Some or all of the functionality attributed herein to the external resources may be provided by resources included in the system.

The central server may be configured to facilitate completion of obligations associated with transactions performed via mobile user platforms based on digital interactive tickets associated with a unique geographical location and/or user preferences, in accordance with one or more implementations. The central server may include electronic storage, at least one processor, and/or other components.

The electronic storage may comprise electronic storage media that electronically stores information. The electronic storage media of the electronic storage may include one or both of system storage that is provided integrally (i.e., substantially non-removable) with the central server and/or removable storage that is removably connectable to the central server.

The processor(s) of the central server may be configured to provide information processing capabilities in the central server. The processor may be configured to execute one or more computer program modules and/or instructions. The computer program modules and/or instructions may be executed to cause the processor to perform methods and/or effectuate features described herein.

In some implementations, a central server may be configured to maintain user-related information or accounts, collect content for transmittal, transmit content or system-related information to the users, and process incoming communications from users, among other things. It should be understood that content refers to any information in a digital format, including audio, graphical, picture, video, text, data or multimedia files, which may be stored in memory. In an exemplary implementation discussed further herein, the content includes transaction data, advertisements, news or other information of interest, wherein the transaction data relates to sales, auctions or general offers for items, services or opportunities to participate in events, whether presently-occurring or upcoming, offered for no cost, sale or trade.

Content may be obtained from a variety of sources, including automated or user-selected sources, and processed for transmittal to the user platforms. Content may be forwarded, obtained, created or otherwise provided to the central server. In some implementations, the system may include the hardware and software necessary to form a content finder component configured for searching applicable locations, such as websites or databases, and obtaining content for subsequent processing and transmittal. The broadcast or transmittal of content may be carried out via any conventional method, which may in part depend on the type of user platform set to receive the content.

In some implementations, the content is filtered based on user preferences or other preset criteria configured to help identify the content to be most likely of interest for each user prior to transmittal thereof. The user preferences used in the filtering process may be obtained from a variety of active or non-active sources, such as queries provided directly to users and by content selections or otherwise information detected that may tend to reveal user interests.

Furthermore, an exemplary system includes the ability to determine the geographical location of the user platform, such as for example, via conventional geographical positioning system, network provided location information such as IP address and cellular communications stations, or otherwise receiving location data from the user platform which may be initiated by user operation. Thus, in some implementations, the content includes information associated with a unique geographical location, such as an event happening at a particular venue within a certain traveling distance, items or services offered for sale at a nearby store or by a third party, or local news of interest.

Content collected may include transaction data regarding upcoming events, wherein each occurs at a particular time and has a unique geographical location. The transaction data can be filtered based on the proximity of the user platform to the respective unique geographical location. The transaction data may be further filtered based on the user's tastes and/or preferences with regard to the features of the event themselves (either user supplied and/or supplied by an intelligent automated software prediction system), such as type of concert or attraction, and/or relative willingness to travel for certain types of events. In some implementations, the filtering process conducts comparative steps involving the satisfaction of certain preset criteria or rules or results generated by intelligent automated software prediction system for each user by characteristics associated with the event prior to transmittal.

In an exemplary implementation, the system of the invention is configured for facilitating the fulfillment of respective obligations relating to an executed transaction. For example, a purchase order or electronic ticket or otherwise proof of an executed transaction may be delivered to the user platform.

In one implementation, the invention is further configured to provide a user with a digital interactive ticket (DIT) that is transferred to the user platform (e.g., a mobile device such as a smartphone, iPod Touch, etc.) upon completion of a transaction. In some implementations, the DIT may contain executable software and requisite data enabling it to provide functionality on the user platform, or the DIT itself may be in the form of an executable file that contains within it digital information and software processes that provide additional functionality to the user platform. The additional functionality may be realized in the context of the invention and configured to facilitate the completion of all obligations relating to the executed transaction. The DIT can function as a receipt in connection with any transaction or payment of any charge, as well as acknowledgement or proof in other matters that may not involve payment. In particular, the DIT is used in some implementations discussed herein as a receipt for the purchase of an entry ticket or to enable payment of a cover charge to an event communicated to a user through the user platform based on the user's proximity to the venue at which the event is set to occur, timing and preferences, or based on delivery due to intelligent software prediction system delivering event information likely to match the user's tastes, or based on delivery of event information that matches the user's time, location, and event genre filters/specifications.

In some implementations, the DIT includes a Super-Redundant Redemption mechanism which is configured to overcome incompatibility issues that may result due to the form of the transaction receipt. Thus, the DIT may be expressed or be automatically transformable into a plurality of formats to comply with the requirements for consummating the executed transaction, and/or facilitate, expedite, or enable the ability to consummate the executed transaction.

For example, the DIT may be configured to include an electronic barcode or wireless handshaking software (e.g., 802.11) which contains encrypted information that facilitates a secure connection with the corresponding system of another party associated with the executed transaction for information exchange.

The DIT may be configured to include a hyperlink that is activated or accessed upon receipt of the DIT, redemption by the user, or automatic detection of the user platform with the DIT in a certain location, wherein the extended URL contains information containing redemption information which may then be transferred to another party associated with the executed transaction, among other things. In some implementations, this information can be sent from a user platform such as an Internet enabled device to the party's redemption website having scripting abilities capable of processing and/or displaying the redemption information, to a platform website which is hosted for that party, to a platform web service which then processes and stores the redemption data for accessibility the party's website or platform website hosted for that party, and/or to another location and/or device(s). It is envisioned that the redemption website may be operated by the other party or hosted by the central server of the invention or server associated with the central server of the invention, thus permitting the other transacting party to realize the benefits of a consolidated system while also avoiding the expenses of hosting, building and maintaining their own system. For example, a consolidated system could be configured to provide real-time information in the other party's preferred format.

The DIT may be configured to include a ticket identification number (TIN), which can be presented in a format with information to be in compliance with the other party's procedures for verifying such tickets.

In some implementations, the DIT includes activated redemption graphics and animation which is intended to facilitate the security of the transaction completion step, and assure counterfeit prevention. In one example, upon redemption of the DIT, a secured and encrypted animation is decoded which results in the animated “ripping” of an illustrated ticket to confirm the completion of the executed transaction. It should be understood that methods may be used to notify the user and/or the other party involved in the transaction of the redemption, including audio, video or graphics. Also, unique symbols, colors or code may be provided on the user platform upon redemption of the DIT as a further security measure, which is comparable to establishments that use special logo stamps or color coded wristbands, the design or color of which change every weekend, in order to verify who has or has not legitimately paid for entrance.

As discussed, the DIT may represent and replace a paper ticket (e.g., a proof-of-purchase). It should also be understood that the DIT may represent a pre-paid cover charge which enables users/customers to skip the conventional method of doing business of waiting in a line to pay the cover charge. The DIT may also provide, via executable software, the user with the ability to pay a fee or assign a tip, to a doorman or bouncer, for example, when interacting with that doorman/bouncer (or any other employee in the venue such as servers), by using an employee identification number, bar-coded tag or other means for identifying the employee. Thus, the DIT provides the user with the ability to use the user platform with a DIT much like a credit card or debit card. For example, the DIT may be used for paying for anything at the venue (drinks, food, bottle service, other services). The steps for such a transaction may include connecting to the venue's infrastructure, selecting the item to purchase, transmitting the authorization amount to a user account, allowing the user/customer to confirm the purchase, forwarding a confirmation code to consummate the purchase upon confirmation by the user. In some implementations, the DIT may be used to distinguish the user as a VIP or otherwise as a recipient of exclusive services, such as line-skipping privileges. It is envisioned that such status may also be provided if the user pays a service charge, which may be deposited immediately in a venue account or a system operator account, or both, for example.

In some implementations, a DIT provided to a mobile user platform may also be able to assist with providing directions to the other party associated with the transaction, as well as, providing directions or a map in the instances where the transaction relates to the purchase of seats at an event or to locate another user via a user platform in accordance with the system, if permitted by the user. Thus, in some implementations, the DIT is configured to present a map to help locate the venue and present a map of the venue or a seating chart to help locate seats within the venue.

In some implementations, a DIT can also include software which permits the user to select reminder notifications and delivery options relating thereto, such as countdowns, periodic reminders, or select to provide notifications to others as instructed by the user. In some instances, the system may offer alternatives to the user through the user platform if it is determined that the user will be unlikely to complete the executed transaction.

For example, if the executed transaction relates to purchase of tickets to an event occurring at a specific time and place, the system may determine that the user platform is at a location which would make it difficult or impossible for the user to attend. Thus, the system may offer the user options to attend a different event or the same event at a different time, if available. The system may also offer to refund a portion of the purchase price, and if agreed to by the user, subsequently notify one or more other users of the availability of the tickets, or notify the event managers that the tickets are once again available for sale. The system may also be configured to facilitate the auction or direct sale the tickets to other potentially interested users, based on their respective user profiles, through the user platform, or act as a broker reselling the ticket via other secondary ticket brokering channels.

If the DIT relates to a cover charge, then in some implementations, the charge may be immediately refunded at events where the venue is at capacity or does not permit entry to someone who has pre-paid the cover charge, via security or other venue employee providing a refund security code to the customer who enters it into the ticket for the refund, or the venue getting the ticket identification number from the customer wirelessly should a user indicate a desire to obtain a refund, and then authorizing the refund, with the transmission back to the user platform confirming that the charge or a portion thereof was refunded.

In some implementations, a DIT is configured to be provided to a user platform on behalf of the user and/or other parties, and includes a transfer feature that permits transmitting the DIT, or a portion of software relating thereto, to the other parties according to the system described herein. For example, a DIT may be provided to a user platform pursuant to an executed transaction involving multiple tickets for an event. In this example, the user may transfer the DIT or a variation thereof to other user platforms or devices which are capable of receiving such data. This can be combined with communications protocols which guarantee that a ticket transfers to the other party conditional upon them agreeing/accepting to reimburse the original ticket holder for the original price of the ticket (or alternatively, a different amount), with the possible inclusion of a transfer fee. This uses any networking infrastructure the mobile device has for doing such, including 802.11, Bluetooth, cellular network, or near-field communications protocols.

In some implementations, the transfer fee may be a set price for the service, based on the sale price or based on the original ticket price. The transfer fee may be automatically included in the cost, paid by either party or otherwise be shared by both parties. Any fees paid through the user platform may be charged to a credit card or automatically deducted from an existing account.

In some implementations, the user platform and/or DIT is configured to facilitate the transfer or redemption thereof through a convenient user gesture, such as shaking the user platform (in the case of a mobile phone or other similarly sized device) or through touch (e.g., dragging a finger across a portion of an image of a ticket which responds by animating the tearing of the ticket in real-time).

In some implementations, the DIT also facilitates further transactions involving the user and user platform. For example, once a DIT provided pursuant to a transaction involving an event having unique seats is redeemed, the DIT can include encrypted information which allows the user to securely communicate with event service providers or staff in order to place concession orders, and make requests or purchases through the user platform. It is envisioned that the user platform may communicate with a suitable infrastructure operated at the event or otherwise communicate with the central server of the invention or a server associated with the invention which is maintained on behalf of another party for the purpose of assisting in additional transactions at the event.

In some implementations, the DIT may be configured to present the user with targeted purchasing options and facilitate their delivery through executable software, processes, data, links, and user information encapsulated within the automated functionality of the DIT. The DIT may be used to facilitate a purchase and provide automatic delivery of the purchased items to the user's home address or another address selected by the user. For example, upon concert tickets being purchased through the system, a paper commemorative ticket may be delivered to the user's address. Additionally, the user may be directed through the user platform to a presentation of an artist/promoter/label's storefront, from which the user may purchase music and/or memorabilia related to the tour such as physical items like T-shirts, art, posters, recorded music albums, or digital content such as recordings of albums, music, live recording of the same event whether audio, video, or both, which may then be shipped to the user.

It should be readily apparent that purchases through the system by a user may be automatically applied to any applicable account, such as the seller's account in the system, an internet service or bank. The account information may be entered into the system for automated payment/debiting or requested from the user.

In some implementations, the system further provides a transaction service component which saves a portion of financial information, such as credit card, account or banking data, and queries the user for the remaining missing portion of information to complete a transaction, thus relieving the user from the burden of entering such information for each transaction while maintaining the integrity and security of the system. For example, half of a user's credit card information may be kept on the user platform and encrypted, while the other half can be stored on the central server, also encrypted, thereby creating a situation where neither the user platform nor the central server has security sensitive credit card information adequate or complete enough to be used against the user if a breach of security occurred. However, the information may be combined to complete a transaction as if the user had already established an online account with the vendor-platform. In some implementations, an algorithm on the user platform takes the whole credit card or account number when it's entered, and generates a non-reversible key, which can be used to verify that the two halves of a credit card (or debit card) “belong” to each other, but cannot be used to reconstruct the card number by itself or in conjunction with only one half of the card number.

In a typical scenario of a 16-digit credit card number, there are exactly 1,000,000,000 (one billion) possible combinations for the other half of the credit card, making typical hacking or guessing scenarios highly infeasible.) The server receives and securely stores one half of the credit card and the non-reversible key. The user platform stores the other half of the credit card in memory, with expiration date and CVC code. A security compromise on the server side or the user platform thus cannot result in a compromise of the credit card account information. When a transaction is authorized by the user, and the user selects which of the credit cards he has on file that he wants to use, but only one half of the card information is sent to the server, which finds the appropriate other half using the non-reversible keys it has in storage. A write-only data service inside the transaction server is internally sent both halves of the credit card (still encrypted), that is, there is no read-access to any system that has a completed credit card number. Users may securely authorize transactions without retyping their credit cards every time and having that information sent via https (secure socket layer with in some implementations the addition of an encryption scheme tied to the nonreversible key or cipher), yet at the same time, without having their complete credit card information on account in any computer system where they have to trust the provider and/or the provider's security system. Users can literally approve transactions with immediate finger gestures on their respective platforms and have billing come out of appropriately selected accounts, without their vital financial account information being stored offline with anyone who has to be a trusted source.

In some implementations, the DIT can be used as a boarding pass, in which case only upon executing the redemption mechanism, the boarding pass security code is displayed to the boarding agent (which provides security and anti-counterfeit measures to ensure the boarding pass is authentic), or wireless connectivity with their 802.11 or other wireless network uses encrypted information inside the DIT to communicate the redemption of the authentic boarding pass to the airline computer system, which then shows that the redemption took place on the boarding agent's screen, or the DIT communicates via Internet on the mobile device to a web server hosted by the platform (or the airline's own web server) to communicate the redemption of the boarding pass, which then updates a real-time refreshed webpage viewed by the boarding agent, letting him know the redemption took place.

In some implementations, the DIT can be used for hotel check-in, similar to the methods for the airline boarding pass. Upon redemption, the DIT communicates directly with the hotel computer's infrastructure wirelessly, all customer information, removing the need for the human operator to do computer search and data entry functions to check the customer in; alternatively, the DIT communicates with an offsite webserver which in real-time refreshes any webpage viewing it, letting the hotel agent see a requested check-in that already has all pertinent information right on the screen for the human operator to enter, and also a “check-in code” is provided on the webpage's screen, which when entered, allows the hotel's existing infrastructure to hit the web service, via API call, and utilizing the check-in code, immediately download all check-in information via JSON, XML or other conventional data exchange format, in order to automatically enter check-in information into the hotel's computer/IT infrastructure in order to effectuate the automatic check-in.

In some implementations, users may store “ripped” or “redeemed” copies of DITs within the applications data “sandbox” or data storage area of the user platform or server, allowing customers to display images of the tickets for past concerts and events they've attended to others, and via URL, internal data storage, or data lookup mechanisms, stored stubs of old digital interactive tickets can be used to directly access the commemorative recording of the concert associated with that ticket.

In some implementations, the system of the invention is configured to provide additional purchasing options after a user purchase of a DIT, which preferably are related to the underlying content involved in the DIT transaction. This “DIT value bundling” allows users to automatically “value bundle” other goods and services with the purchase of the DIT. Some examples include providing a souvenir commemorative ticket for an added fee to the customer's mailing address, for those enthusiasts who like to keep stubs of all events they've ever attended for nostalgic purposes; and providing commemorative recording through partnerships and licensing deals to users purchasing a DIT for a concert, thus providing immediate download access to recordings of the very concert the user will attend, accessible through the digital ticket stub for download (or other login mechanism on the mobile device or other internet enabled device), to get a digital recording of the event the user attended for their personal music collection. This method of doing business provides artist, venue, and other licensing partner with proceeds otherwise lost to the bootleg recording industry, and provides the user with the immediate convenience of automatically receiving commemorative recordings of all music concerts he attends.

In some implementations, user preferences are at least partially determined and honed by developing and updating a unique user profile, with one of the goals of the development of the user profile being to provide content that would most likely be of interest to the user, and in a manner or timing which would be preferable to the user.

The user can actively enter preferences which are used to further enhance the user profile. In some implementations, users may be surveyed using a hybrid binary tree algorithmic method designed to gather desirable demographic and preference data from the user in the least amount of questions. The user may also be asked to enter in basic status and background information about themselves, including their age, gender, marital status, place of birth, and residence location, among other things. Depending on content interests, or executed transactions, users may also receive inquiries or provide ratings. For example, after attending an event in which tickets were purchased using the system, users may be asked to rate or comment on the venue, services, features and underlying attraction or performance.

Users also passively provide information which is processed and used to enhance the user profile along with the actively provided data. In some implementations, passively collected user data is obtained by tracking user interactions with the system and their respective use of the user platform. In some implementations, the system may be accessed and a transaction recorded in the user platform and configured to detect certain user operations. For example, if a user purchases tickets to an event, the system may record and compile information relating to the event, such as the type of event, artist, venue, genre, etc., and use this information, along with any existing user profile information, to further develop and enhance the user profile to better understand the user's preferences.

The user platform itself, as well as user accounts with online music services (e.g., Pandora, Last.fm, Rhapsody, etc.) may be scanned to obtain information useful for the purpose of developing the user profile. For example, many user platforms, such as mobile phones, include music file playing functionality and it has become increasingly popular for users of such devices to maintain large collections of music files on these devices, or music collections and/or music preference information on their online music accounts. These collections can be scanned for information relating to the music files, such as the artist, type of music, relative amounts of different types of music, numbers of times each file has been played, user rankings/ratings of individual songs, and then processed by the system to further develop the profile. Many user platforms are customizable with software features or downloadable applications, such as games, social networking programs, instant message or email services, which may also be detected and used by the system for profile enhancement.

The compiled information whether provided by user submission, recorded from user activity or scanned without user intervention, may be compared with statistical correlation system, intelligent software prediction system, pattern recognition formulas or programs used for processing raw recorded user data to determine the most likely preferences in other areas of interest in addition to developing a comprehensive user profile. The continual collection and processing of information over time may be used to track general user preferences over time for comparable users, which may further assist the system in developing profiles and predicting greater user trends and correlating interests for comparable users or groupings of users. Thus, in some implementations, content provision and recommendations based on specific user interests and/or correlations between user profiles may be directed to users accordingly through the user platform. In particular, transactions for items or services, such as tickets to an event occurring within a certain time and distance from the user, may be flagged as something of interest to the user based on the user profile and forwarded to the user platform. It should be readily apparent that response to such content may further impact the user profile and further content may be provided as a result. For example, the purchase of tickets to an event, and purchases of items or services during the event as provided by the venue or otherwise, may be used as an indicator of interest or taste, and thereafter used along with other information to enhance the intelligent prediction system of the invention.

In some implementations, the user experience is further enhanced by customizing content, and in particular, customizing prior user feedback to content so that users either view feedback from other users with similar specific preferences or generally comparable user profiles. For example, a user interested in purchasing a particular item or service may be provided with ratings only from other users falling within a certain range of similar tastes that have previously purchased the item or service, or even a similar item or service, or receive ratings along with an indication of which ratings are from users with similar interests, so that the interested user will be better able to ascertain how they might rate the event accordingly.

In some implementations, the system includes a social networking component which allows users to communicate with one another via the user platforms, or automated connectivity through other popular social networking platforms. It should be readily apparent that the system may facilitate communication between users of all kinds, including users having similar interests or generally comparable profiles, or even users having diametrically opposed user profiles. The use of taste profile filters, GPS location, attendance of same events, and other information specific the invention's platform, as the means or filter for selecting social networking opportunities, is a novel aspect of the invention platform.

In some implementations, the presentation of targeted information, potential transactions or other opportunities may be accomplished through “push” notifications sent to the user platform. Push notifications may be provided in scenarios discussed herein, such as, during attendance of a concert where offers of items or services for sale may be sent to users in connection with the underlying event or for other reasons based on the user's interest in the event. The system may utilize push notifications in social networking context to encourage group participation. For example, upon purchasing a DIT relating to an event, the user may use the push notifications to send notification of the purchase to contacts or friends on any conventional social networking site which also is configured to facilitate the purchase of tickets, possibly for adjacent seats to the user, by the contact or friend. Alternatively, the same functionality may be provided through messages sent that contain executable software or hyperlinks to webpages for purchasing tickets or other items.

In some implementations, the user platform and system may be configured to continually determine the location of users (through the location of the user platform) relative to content, such as nearby events, services, amenities, activities, items for sale, etc., identify such content that may be of interest to the user, based on the user preferences and/or intelligent predictive system comparison of the particular content to the current user profile, and notify the user of such content, while also pointing out any time-sensitive content, such as the upcoming occurrence of a unique event, if applicable. The notification may be provided through push notification system to make it easier for the user to indicate a desire to participate, purchase or otherwise engage in the activity presented through the push notification.

As discussed above, the system of the invention is not limited to any source for content, and may obtain content for transmission to users through a variety of sources. In some implementations, the procurement and aggregation of content to be presented to users regarding events, products and services available for a DIT-enabled purchase may include a variety of sources, some of which are described herein.

In one example, the system of the invention may employ software data mining, in that software on the central server “data mines” digital sources and compiles the event listings into a component of the system (referred to hereinafter as “EventScout”), providing the central server with a source of event listing information. This includes but is not limited to: ticket broker websites, regional event websites, exposed Internet application programming interfaces (API's) for querying events, venue websites, social networking accounts/pages/API's for events, and so on.

In another example, the system of the invention may employ human data mining, in that compiled information, via user interface, would be inputted directly into the EventScout database. This includes newspapers, chamber of commerce, magazines and publications, regional website surfing, use of other mobile apps that present event information, telephone calls to venues, use of social networking pages, etc.

In yet another example, the system of the invention may employ user event entry. Users often know about smaller and lesser events that are not advertised or well known (such as a local cribbage championship or poetry gathering), and are thus provided an interface via the user platform for entering their own events for potential dissemination to targeted users.

In yet another example, content suppliers, such as venues, stores, private sellers, service providers, online and printed publications and the like, may engage in a relationship with one or more proprietors of individual components of the system or otherwise be provided with the ability to post or input content on the system. In some implementations, the system is configured to also automatically post such content in multiple marketing locations or sites where potential interested customers may view the listing, thus avoiding the time-consuming inconvenience of placing duplicating listings in multiple locations. For example, a venue may access a user interface provided for venue content suppliers which is configured to receive key event information, such as artist information, time, date, promotional description, photos, video/music samples, etc., which will be saved in the central server and forwarded to targeted users via user platforms as well as posted to sources such as social networking sites and services (e.g., “Facebook,” “Twitter,” or “mySpace”), online and printed publications and events listings websites, among other things. It thereby provides value to the venue in marketing the event more easily, while also providing the central server with event listing information. Furthermore, it allows suppliers to manage their inventory and operations via a standardized protocol for inspection, analytics and transaction, referred to herein as “OpenTicket.” For example, a venue may utilize the central server to conduct a query through a content supplier interface with the system, all OpenTicket users to determine information on upcoming events.

In some implementations, the central server is configured to act as agent for logging into a user's social networking accounts, on behalf of them, to gather information on their contacts, such as which of their friends are already going to events (RSVP), which of their friends have notified them of events, and to, via these agent actions, propagate further notifications through other social networks about their own attendance of events, knowledge of events, intent to attend future events, and so on. Information regarding the user's contacts or social networking page may also be collected to enhance the user taste profile and predictive system.

Users may also enter their own events into EventScout but categorize the event as private (such as a house party, etc.), and then publicize the private event to other users who are listed as contacts or friends or otherwise included in the user's social network, whether through alert/notification, and/or inclusion of private events on the list of events that are displayed to their friends using the platform, and/or automatically propagating the private event through the user's other social networking accounts. Users may also host or organize private parties and send out social networking alerts (via text, email, push notification), invites, information, news, etc., to unknown users of the network based on filters such as having overall comparable tastes, GPS location, sharing comparable tastes in certain things, etc., as provided by the user profiles and predictive system of the invention.

In some implementations, the system is configured to enable users to interact with a checklist of friends in their social network (or others based on profile, GPS location, etc.) to alert/invite to a private hosted event, then also have that event in the event listings show up any time those users interact with the platform; organize social networked friends into user defined categorical social groups such as business, family, best friends, lesser friends, acquaintances, friends of friends, and so on; set up exclusionary relationships where a pair of friends are flagged for not being invited to the same event (and if they both are, whoever first responds or RSVP's will trigger an event erasing the event from being viewable by the other); and, instead of the effort of going through a checklist individually, select to invite mass groups and exclude other mass groups based on group checklists.

It should be readily apparent that transaction, whether private or otherwise, may be facilitated with a DIT. The DIT may also execute one or more queries to the user before/during/after the event, soliciting the user's opinion, ranking, comments, etc. The queries may not be limited to the subject of the transaction. For example, if the transaction relates to an event, the queries may also relate to individual acts, artists, the venue, and so on. Certain user controls can provide further information to the user profile information, such as controls allowing 5-star rankings, thumbs-up thumbs-down, and so on.

As discussed above, in some implementations, the presentation of content, such as a listing of events, products or services in a menu, is ranked according to the intelligent software prediction system's determination that the characteristics of the content (e.g., event product or service) either matches features of the user's taste profile within a desired degree of probability or possesses a sufficient likelihood of being of interest to the user as predicted based on the user's taste profile. The system may be configured to also provide weighted rankings of content (such as for example, a ranking of from 1 to 5 stars), that is, rankings which are displayed to the requesting user based on the intelligent software prediction system's weighting of user votes according to the relative similarity between voting users and the requesting user, as determined by a comparison of respective taste profiles. For example, a first user's vote or ranking of content having a similar profile to the user assessing the content may be counted as a greater amount of votes as compared to a second user's vote or ranking if that second user's profile is less similar to the assessor than the profile of the first user, as determined based on pattern recognition intelligence incorporated in the system of the invention.

It should be readily apparent that ratings or comments which have been submitted from voters having similar tastes to the user are more likely to be of greater helpful value to a user who is considering options or in reaching a decision. In some implementations, the system of the invention incorporates recommendations based on knowledge prediction, sophisticated statistical correlation, and pattern recognition algorithms to generate intelligent recommendations, and utilizes this functionality to provide a personalized rating system, rather than a universal one-rating-fits-all “democratic” rating system. Thus, the process of assessing input from voters can be adjusted in accordance with the relative taste similarities, either overall or in one or more specific areas, between each respective voter to the user who is interested in receiving a personalized rating.

In providing the system as described herein, the system of the invention is configured and adapted to interact with users in such a way that each interaction is detected and analyzed to enhance the user taste profile and predictive system. For example, interactions which may affect the user profile may include interactions: via the user-interface supplying a method of immediately providing rankings, checkboxes with thumbs-up/thumbs-down, etc; via finger gestures (or other user interface controls) which slide an event higher on the list or lower on the list as an indicator of greater or lesser interest/taste matching; via the mere fact that a user selects an event to look at it for more information, being an indicator that there is some higher degree of interest for such an event; via a finger gesture (or other user interface control) which allows the user to slide an event right out of the list because it is a bad match to his taste; via user interface components which allow an indecisive user to indicate he may in the future be interested in going to this event or a future recurrence of similar events by the same artist (or at the same venue); via the user being able to rate the venue while looking at detail information on the event (or detail information on the venue which is can be triggered when looking at detail information on the event); via the mere fact that the user interacts with social networking options which are presented in detail information about the event, such as invitations, etc.; via the fact that the user considered purchasing a ticket (but may or may not have consummated the purchase); via the GPS location of the user's location when using the application, providing insight into the activities and interests of the user (such as if the user is located in an amusement park, certain business, restaurant, nightclub, or boutiques, etc.), or identified by the system as being in attendance at a particular event taking place at that time/location while accessing the system through the user platform.

In some implementations, the transaction server provides services to the Core Platform Processes, upon the CPP retrieving information from the Ticket Procurement Application on available seats, to transact the purchase of tickets from the venue, or intermediary (e.g. ticket broker). The Core Platform Processes represents a “middle tier” server layer in the client/server architecture, in that it performs all the business application logic and mediates between the database layer and its stored data, and the client layer which makes requests of the middle tier for it to organize, structure, and deliver data according to the provided filters supplied by its requests.

The central server and/or other components of the system may include a TasteTrak Application. The TasteTrak Application semi-autonomously resides within the CPP. This server application component accesses all pertinent information about artists, events, venues, and user tastes, and implements artificial intelligence, pattern recognition, statistical correlation methodologies, and knowledge prediction system, in order to help the CPP filter requests from users in order to supply them information about the venues, artists, and events: specifically, “taste match rankings” (one-dimensional value whose magnitude from low to high represents low taste match to high taste match, respectively).

The central server and/or other components of the system may include a Client Server Communications Layer. The Client Server Communications Layer provides various API's, methods, services and interfaces to the numerous client types with their various formats and protocols, of the type which will be making requests of the server. This layer's job includes translating these into a single standardized format to pass on to the Core Platform Processes, and likewise, obtaining communications from CPP and translate them back into the various formats expected of the diverse client types.

The central server and/or other components of the system may include an EventScout Aggregator Application. The EventScout Aggregator Application is a server-side master application (composite application) which includes a system of sub-applications which aggregate information from the wide diversity of sources for receiving event information, that have been specified elsewhere. It is responsible for obtaining all the key event information that goes into the databases of the server-side data layer.

The central server and/or other components of the system may include a Venue Event Publication Application. The Venue Event Publication Application is an application provided to venues, which includes a web portal and/or web application. It enables venues that currently have to redundantly replicate marketing efforts for events through multiple channels (e.g., “Facebook,” “mySpace,” local events websites, newspapers, etc.), with a single interface from which they can post their event information once, and which then gets posted across multiple channels automatically upon submission. In this implementation, one of the channels is the Event Scout system. This free service may be provided in exchange for marketing concessions such as the venue accepting the use of the DIT, VIP status for digital interactive ticket customers (e.g., not forcing DIT customers to wait in line with other customers who are waiting simply to pay for a ticket the DIT customer has already purchased), door and window decal marketing, and indoor poster marketing. One of the key aspects is that this feature is a marketing tool to give venues a valuable service for free, accept concessions that are essentially at no cost to them (indeed, these features provide extra functionality and prestige to the venue), yet also create a network for the system of the invention to gather more complete event listings than any other service, and, use the system's DIT revenue model directly with the venue.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate completion of obligations associated with transactions performed via mobile user platforms based on digital interactive tickets associated with a unique geographical location and/or user preferences, in accordance with one or more implementations.

FIG. 2 is a flowchart illustrating a method for facilitating completion of obligations associated with transactions performed via mobile user platforms based on digital interactive tickets associated with a unique geographical location and/or user preferences, in accordance with one or more implementations.

### DETAILED DESCRIPTION

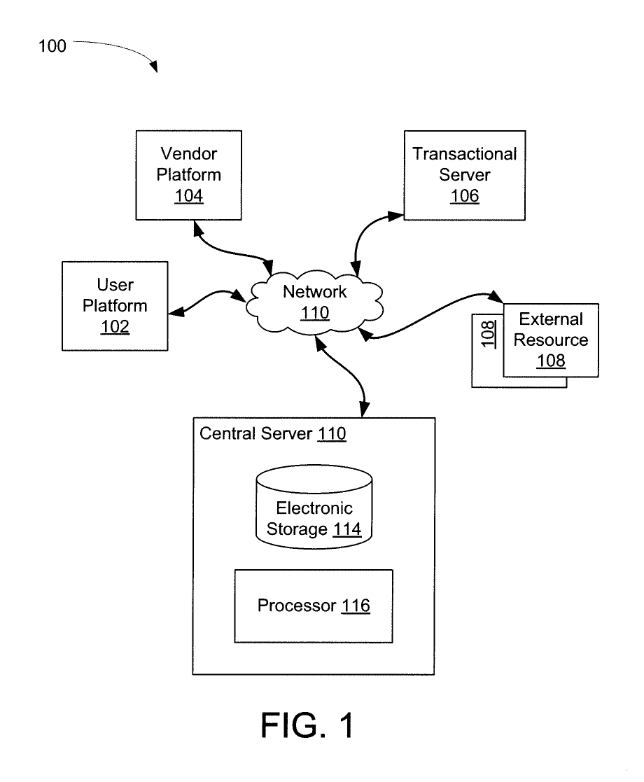

FIG. 1 illustrates a system 100 configured to facilitate completion of obligations associated with transactions performed via mobile user platforms based on digital interactive tickets associated with a unique geographical location and/or user preferences, in accordance with one or more implementations. The system 100 may implement one or more features described herein. As depicted, the system 100 may include at least one user platform 102, at least one vendor platform 104, at least one transaction server 106, one or more external resources 108, at least one central server 110, and/or other components, all being communicatively coupled to a network 112.

The network 112 may include the Internet and/or other networks. It will be appreciated that this is not intended to be limiting, and that the scope of this disclosure includes implementations in which the user platform 102, the sponsor server 104, the external resources 108, the central server 110, and/or other components are operatively linked via some other communication media.

Those skilled in the art will also readily appreciate that a system 100 in accordance with the present disclosure may include the various computer and network related software and hardware typically used in a mobile communication system and distributed computing networks, that is, programs, operating system, memory storage devices, data input/output devices, data processors, servers with links to data communication system, wireless or otherwise, such as those which take the form of a local or wide area network, and a plurality of data transceiving terminals within the network, such as personal computers and hand-held devices. Those skilled in the art will further appreciate that, so long as its users are provided with access to a system 100 in accordance with the disclosure, the precise type of network and associated hardware are not vital to its full implementation.

The user platform 102 may be configured to receive content and communicate with the central server 110 in connection with the content, setting up an account or indicating preferences for example. The communication may also result in the execution of a transaction provided to the user in the transaction data. The system 100 may also be configured to facilitate communication between users, such as by providing text messaging applications or other applications which allow for data to be transferred wirelessly directly between user platforms.

The user platform 102 may include one or more processors configured to execute computer program modules. The computer program modules may be configured to enable one or more users associated with the user platform 102 to interface with the system 100, the vendor platform 104, the transaction server 106, the external resources 108, the central server 110, and/or other components, and/or provide other functionality attributed herein to the user platform 102. By way of non-limiting example, the user platform 102 may include one or more of a desktop computer, a laptop computer, a handheld computer, a NetBook, a Smartphone, and/or other computing platforms. As such, the user platform 102 may include one or more user interface devices. Examples of such user interface devices include a screen, a touch pad, a touch screen, a keyboard, a keypad, and/or other user interface devices suitable to facilitate interactions and/or information transfer between the user platform 102 and a user.

In some implementations, the user platform 102 may include one or more Thin Clients. The Thin Clients may include a software application that resides on the user platform 102, such as a user's internet enabled device, which is responsible for portraying user interface, data display, interaction, and a limited amount of local storage (digital interactive tickets and so forth), or a web page/web browser interface that mimics the aforementioned functionality of the software application residing on the user platform 102 but which can be accessed from any device with a web browser without the installation of user device-specific software.

One or more interfaces of system 100 discussed herein may employ graphical user interfaces (GUIs) transmitted or downloaded to the user platform 102. The GUIs can incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons and other user interface controls. These features can be selected (i.e., “clicked on”) by the user via connected mouse, keyboard, voice command or other commonly used tool for indicating a preference, including a user-specified action, in a computerized graphical interface.

The external resources 108 may include sources of information, hosts and/or providers of web sites and/or services outside of the system 100, external entities participating with the system 100, and/or other resources. In some implementations, the external resources 108 may include social networking web sites, content providers, and/or other resources. Some or all of the functionality attributed herein to the external resources 108 may be provided by resources included in the system 100.

The central server 110 may be configured to facilitate completion of obligations associated with transactions performed via mobile user platforms based on digital interactive tickets associated with a unique geographical location and/or user preferences, in accordance with one or more implementations. The central server 110 may include electronic storage 114, at least one processor 116, and/or other components.

The electronic storage 114 may comprise electronic storage media that electronically stores information. The electronic storage media of the electronic storage 114 may include one or both of system 100 storage that is provided integrally (i.e., substantially non-removable) with the central server 110 and/or removable storage that is removably connectable to the central server 110 via, for example, a port (e.g., a USB port, a firewire port, etc.) or a drive (e.g., a disk drive, etc.). The electronic storage 114 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 114 may store software algorithms, information determined by processor 116, information received from the user platform 102, the vendor platform 104, the transaction server 106, the external resources 108, information associated with features described herein, and/or other information that enables the central server 110 to function as described herein.

The processor 116 may be configured to provide information processing capabilities in the central server 110. As such, the processor 116 may include one or more of a digital processor, an analog processor, a digital circuit designed to process information, an analog circuit designed to process information, a state machine, and/or other mechanisms for electronically processing information. Although the processor 116 is shown in FIG. 1 as a single entity, this is for illustrative purposes only. In some implementations, the processor 116 may include a plurality of processing units. These processing units may be physically located within the same device, or the processor 116 may represent processing functionality of a plurality of devices operating in coordination.

As is shown in FIG. 1, the processor 116 may be configured to execute one or more computer program modules and/or instructions. The processor 116 may be configured to execute the computer program modules and/or instructions by software; hardware; firmware; some combination of software, hardware, and/or firmware; and/or other mechanisms for configuring processing capabilities on the processor 116. The computer program modules and/or instructions may be executed to cause the processor 116 to perform methods and/or effectuate features described herein.

In some implementations, a central server 110 may be configured to maintain user-related information or accounts, collect content for transmittal, transmit content or system 100-related information to the users, and process incoming communications from users, among other things. It should be understood that content refers to any information in a digital format, including audio, graphical, picture, video, text, data or multimedia files, which may be stored in memory. In an exemplary implementation discussed further herein, the content includes transaction data, advertisements, news or other information of interest, wherein the transaction data relates to sales, auctions or general offers for items, services or opportunities to participate in events, whether presently-occurring or upcoming, offered for no cost, sale or trade.

Content may be obtained from a variety of sources, including automated or user-selected sources, and processed for transmittal to the user platforms. Content may be forwarded, obtained, created or otherwise provided to the central server 110. In some implementations, the system 100 may include the hardware and software necessary to form a content finder component configured for searching applicable locations, such as websites or databases, and obtaining content for subsequent processing and transmittal. The broadcast or transmittal of content may be carried out via any conventional method, which may in part depend on the type of user platform 102 set to receive the content.

In some implementations, the content is filtered based on user preferences or other preset criteria configured to help identify the content to be most likely of interest for each user prior to transmittal thereof. The user preferences used in the filtering process may be obtained from a variety of active or non-active sources, such as queries provided directly to users and by content selections or otherwise information detected that may tend to reveal user interests.

Furthermore, an exemplary system 100 includes the ability to determine the geographical location of the user platform 102, such as for example, via conventional geographical positioning system, network provided location information such as IP address and cellular communications stations, or otherwise receiving location data from the user platform 102 which may be initiated by user operation. Thus, in some implementations, the content includes information associated with a unique geographical location, such as an event happening at a particular venue within a certain traveling distance, items or services offered for sale at a nearby store or by a third party, or local news of interest.

Content collected may include transaction data regarding upcoming events, wherein each occurs at a particular time and has a unique geographical location. The transaction data can be filtered based on the proximity of the user platform 102 to the respective unique geographical location. The transaction data may be further filtered based on the user's tastes and/or preferences with regard to the features of the event themselves (either user supplied and/or supplied by an intelligent automated software prediction system), such as type of concert or attraction, and/or relative willingness to travel for certain types of events. In some implementations, the filtering process conducts comparative steps involving the satisfaction of certain preset criteria or rules or results generated by intelligent automated software prediction system for each user by characteristics associated with the event prior to transmittal.

In an exemplary implementation, the system 100 of the invention is configured for facilitating the fulfillment of respective obligations relating to an executed transaction. For example, a purchase order or electronic ticket or otherwise proof of an executed transaction may be delivered to the user platform 102.

In one implementation, the invention is further configured to provide a user with a digital interactive ticket (DIT) that is transferred to the user platform 102 (e.g., a mobile device such as a smartphone, iPod Touch, etc.) upon completion of a transaction. In some implementations, the DIT may contain executable software and requisite data enabling it to provide functionality on the user platform 102, or the DIT itself may be in the form of an executable file that contains within it digital information and software processes that provide additional functionality to the user platform 102. The additional functionality may be realized in the context of the invention and configured to facilitate the completion of all obligations relating to the executed transaction. The DIT can function as a receipt in connection with any transaction or payment of any charge, as well as acknowledgement or proof in other matters that may not involve payment. In particular, the DIT is used in some implementations discussed herein as a receipt for the purchase of an entry ticket or to enable payment of a cover charge to an event communicated to a user through the user platform 102 based on the user's proximity to the venue at which the event is set to occur, timing and preferences, or based on delivery due to intelligent software prediction system 100 delivering event information likely to match the user's tastes, or based on delivery of event information that matches the user's time, location, and event genre filters/specifications.

In some implementations, the DIT includes a Super-Redundant Redemption mechanism which is configured to overcome incompatibility issues that may result due to the form of the transaction receipt. Thus, the DIT may be expressed or be automatically transformable into a plurality of formats to comply with the requirements for consummating the executed transaction, and/or facilitate, expedite, or enable the ability to consummate the executed transaction.

For example, the DIT may be configured to include an electronic barcode or wireless handshaking software (e.g., 802.11) which contains encrypted information that facilitates a secure connection with the corresponding system 100 of another party associated with the executed transaction for information exchange.

The DIT may be configured to include a hyperlink that is activated or accessed upon receipt of the DIT, redemption by the user, or automatic detection of the user platform 102 with the DIT in a certain location, wherein the extended URL contains information containing redemption information which may then be transferred to another party associated with the executed transaction, among other things. This information can be sent from a user platform 102 such as an Internet enabled device to the party's redemption website having scripting abilities capable of processing and/or displaying the redemption information. It is envisioned that the redemption website may be operated by the other party or hosted by the central server 110 of the invention or server associated with the central server 110 of the invention, thus permitting the other transacting party to realize the benefits of a consolidated system 100 while also avoiding the expenses of hosting, building and maintaining their own system 100. For example, a consolidated system 100 could be configured to provide real-time information in the other party's preferred format.

The DIT may be configured to include a ticket identification number (TIN) which can be presented in a format with information to be in compliance with the other party's procedures for verifying such tickets.

In some implementations, the DIT includes activated redemption graphics and animation which is intended to facilitate the security of the transaction completion step, and assure counterfeit prevention. In one example, upon redemption of the DIT, a secured and encrypted animation is decoded which results in the animated “ripping” of an illustrated ticket to confirm the completion of the executed transaction. It should be understood that methods may be used to notify the user and/or the other party involved in the transaction of the redemption, including audio, video or graphics. Also, unique symbols, colors or code may be provided on the user platform 102 upon redemption of the DIT as a further security measure, which is comparable to establishments that use special logo stamps or color coded wristbands, the design or color of which change every weekend, in order to verify who has or has not legitimately paid for entrance.

As discussed, the DIT may represent and replace a paper ticket. It should also be understood that the DIT may represent a pre-paid cover charge which enables users/customers to skip the conventional method of doing business of waiting in a line to pay the cover charge. The DIT may also provide, via executable software, the user with the ability to pay a fee or assign a tip, to a doorman or bouncer, for example, when interacting with that doorman/bouncer (or any other employee in the venue such as servers), by using an employee identification number, bar-coded tag or other means for identifying the employee. Thus, the DIT provides the user with the ability to use the user platform 102 with a DIT much like a credit card or debit card. For example, the DIT may be used for paying for anything at the venue (drinks, food, bottle service, other services). The steps for such a transaction may include connecting to the venue's infrastructure, selecting the item to purchase, transmitting the authorization amount to a user account, allowing the user/customer to confirm the purchase, forwarding a confirmation code to consummate the purchase upon confirmation by the user. In some implementations, the DIT may be used to distinguish the user as a VIP or otherwise as a recipient of exclusive services, such as line-skipping privileges. It is envisioned that such status may also be provided if the user pays a service charge, which may be deposited immediately in a venue account or a system 100 operator account, or both, for example.

In some implementations, a DIT provided to a mobile user platform 102 may also be able to assist with providing directions to the other party associated with the transaction, as well as, providing directions or a map in the instances where the transaction relates to the purchase of seats at an event or to locate another user via a user platform 102 in accordance with the system 100, if permitted by the user. Thus, in some implementations, the DIT is configured to present a map to help locate the venue and present a map of the venue or a seating chart to help locate seats within the venue.

In some implementations, a DIT can also include software which permits the user to select reminder notifications and delivery options relating thereto, such as countdowns, periodic reminders, or select to provide notifications to others as instructed by the user. In some instances, the system 100 may offer alternatives to the user through the user platform 102 if it is determined that the user will be unlikely to complete the executed transaction.

For example, if the executed transaction relates to purchase of tickets to an event occurring at a specific time and place, the system 100 may determine that the user platform 102 is at a location which would make it difficult or impossible for the user to attend. Thus, the system 100 may offer the user options to attend a different event or the same event at a different time, if available. The system 100 may also offer to refund a portion of the purchase price, and if agreed to by the user, subsequently notify one or more other users of the availability of the tickets, or notify the event managers that the tickets are once again available for sale. The system 100 may also be configured to facilitate the auction or direct sale the tickets to other potentially interested users, based on their respective user profiles, through the user platform 102, or act as a broker reselling the ticket via other secondary ticket brokering channels.

If the DIT relates to a cover charge, then in some implementations, the charge may be immediately refunded at events where the venue is at capacity or does not permit entry to someone who has pre-paid the cover charge, via security or other venue employee providing a refund security code to the customer who enters it into the ticket for the refund, or the venue getting the ticket identification number from the customer wirelessly should a user indicate a desire to obtain a refund, and then authorizing the refund, with the transmission back to the user platform 102 confirming that the charge or a portion thereof was refunded.

In some implementations, a DIT is configured to be provided to a user platform 102 on behalf of the user and/or other parties, and includes a transfer feature that permits transmitting the DIT, or a portion of software relating thereto, to the other parties according to the system 100 described herein. For example, a DIT may be provided to a user platform 102 pursuant to an executed transaction involving multiple tickets for an event. In this example, the user may transfer the DIT or a variation thereof to other user platforms or devices which are capable of receiving such data. This can be combined with communications protocols which guarantee that a ticket transfers to the other party conditional upon them agreeing/accepting to reimburse the original ticket holder for the original price of the ticket (or alternatively, a different amount), with the possible inclusion of a transfer fee. This uses any networking infrastructure the mobile device has for doing such, including 802.11, Bluetooth, cellular network, or near-field communications protocols.

In some implementations, the transfer fee may be a set price for the service, based on the sale price or based on the original ticket price. The transfer fee may be automatically included in the cost, paid by either party or otherwise be shared by both parties. Any fees paid through the user platform 102 may be charged to a credit card or automatically deducted from an existing account.

In some implementations, the user platform 102 and/or DIT is configured to facilitate the transfer or redemption thereof through a convenient user gesture, such as shaking the user platform 102 (in the case of a mobile phone or other similarly sized device) or through touch (e.g., dragging a finger across a portion of an image of a ticket which responds by animating the tearing of the ticket in real-time).

In some implementations, the DIT also facilitates further transactions involving the user and user platform 102. For example, once a DIT provided pursuant to a transaction involving an event having unique seats is redeemed, the DIT can include encrypted information which allows the user to securely communicate with event service providers or staff in order to place concession orders, and make requests or purchases through the user platform 102. It is envisioned that the user platform 102 may communicate with a suitable infrastructure operated at the event or otherwise communicate with the central server 110 of the invention or a server associated with the invention which is maintained on behalf of another party for the purpose of assisting in additional transactions at the event.

In some implementations, the DIT may be configured to present the user with targeted purchasing options and facilitate their delivery through executable software, processes, data, links, and user information encapsulated within the automated functionality of the DIT. The DIT may be used to facilitate a purchase and provide automatic delivery of the purchased items to the user's home address or another address selected by the user. For example, upon concert tickets being purchased through the system 100, a paper commemorative ticket may be delivered to the user's address. Additionally, the user may be directed through the user platform 102 to a presentation of an artist/promoter/label's storefront, from which the user may purchase music and/or memorabilia related to the tour such as physical items like T-shirts, art, posters, recorded music albums, or digital content such as recordings of albums, music, live recording of the same event whether audio, video, or both, which may then be shipped to the user.

It should be readily apparent that purchases through the system 100 by a user may be automatically applied to any applicable account, such as the seller's account in the system 100, an internet service or bank. The account information may be entered into the system 100 for automated payment/debiting or requested from the user.

In some implementations, the system 100 further provides a transaction service component which saves a portion of financial information, such as credit card, account or banking data, and queries the user for the remaining missing portion of information to complete a transaction, thus relieving the user from the burden of entering such information for each transaction while maintaining the integrity and security of the system 100. For example, half of a user's credit card information may be kept on the user platform 102 and encrypted, while the other half can be stored on the central server 110, also encrypted, thereby creating a situation where neither the user platform 102 nor the central server 110 has security sensitive credit card information adequate or complete enough to be used against the user if a breach of security occurred. However, the information may be combined to complete a transaction as if the user had already established an online account with the vendor-platform. In some implementations, an algorithm on the user platform 102 takes the whole credit card or account number when it's entered, and generates a non-reversible key, which can be used to verify that the two halves of a credit card (or debit card) “belong” to each other, but cannot be used to reconstruct the card number by itself or in conjunction with only one half of the card number.

In a typical scenario of a 16-digit credit card number, there are exactly 1,000,000,000 (one billion) possible combinations for the other half of the credit card, making typical hacking or guessing scenarios highly infeasible.) The server receives and securely stores one half of the credit card and the non-reversible key. The user platform 102 stores the other half of the credit card in memory, with expiration date and CVC code. A security compromise on the server side or the user platform 102 thus cannot result in a compromise of the credit card account information. When a transaction is authorized by the user, and the user selects which of the credit cards he has on file that he wants to use, but only one half of the card information is sent to the server, which finds the appropriate other half using the non-reversible keys it has in storage. A write-only data service inside the transaction server 106 is internally sent both halves of the credit card (still encrypted), that is, there is no read-access to any system 100 that has a completed credit card number. Users may securely authorize transactions without retyping their credit cards every time and having that information sent via https (secure socket layer), yet at the same time, without having their complete credit card information on account in any computer system 100 where they have to trust the provider and/or the provider's security system 100. Users can literally approve transactions with immediate finger gestures on their respective platforms and have billing come out of appropriately selected accounts, without their vital financial account information being stored offline with anyone who has to be a trusted source.

In some implementations, the DIT can be used as a boarding pass, in which case only upon executing the redemption mechanism, the boarding pass security code is displayed to the boarding agent (which provides security and anti-counterfeit measures to ensure the boarding pass is authentic), or wireless connectivity with their 802.11 or other wireless network uses encrypted information inside the DIT to communicate the redemption of the authentic boarding pass to the airline computer system, which then shows that the redemption took place on the boarding agent's screen, or the DIT communicates via internet on the mobile device to a web server hosted by the platform (or the airline's own web server) to communicate the redemption of the boarding pass, which then updates a real-time refreshed webpage viewed by the boarding agent, letting him know the redemption took place.

In some implementations, the DIT can be used for hotel check-in, similar to the methods for the airline boarding pass. Upon redemption, the DIT communicates directly with the hotel computer's infrastructure wirelessly, all customer information, removing the need for the human operator to do computer search and data entry functions to check the customer in; alternatively, the DIT communicates with an offsite webserver which in real-time refreshes any webpage viewing it, letting the hotel agent see a requested check-in that already has all pertinent information right on the screen for the human operator to enter, and also a “check-in code” is provided on the webpage's screen, which when entered, allows the hotel's existing infrastructure to hit the web service, via API call, and utilizing the check-in code, immediately download all check-in information via JSON, XML or other conventional data exchange format, in order to automatically enter check-in information into the hotel's computer/IT infrastructure in order to effectuate the automatic check-in.

In some implementations, users may store “ripped” or “redeemed” copies of DITs within the applications data “sandbox” or data storage area of the user platform 102, allowing customers to display images of the tickets for past concerts and events they've attended to others, and via URL, internal data storage, or data lookup mechanisms, stored stubs of old digital interactive tickets can be used to directly access the commemorative recording of the concert associated with that ticket.

In some implementations, the system 100 of the invention is configured to provide additional purchasing options after a user purchase of a DIT, which preferably are related to the underlying content involved in the DIT transaction. This “DIT value bundling” allows users to automatically “value bundle” other goods and services with the purchase of the DIT. Some examples include providing a souvenir commemorative ticket for an added fee to the customer's mailing address, for those enthusiasts who like to keep stubs of all events they've ever attended for nostalgic purposes; and providing commemorative recording through partnerships and licensing deals to users purchasing a DIT for a concert, thus providing immediate download access to recordings of the very concert the user will attend, accessible through the digital ticket stub for download (or other login mechanism on the mobile device or other internet enabled device), to get a digital recording of the event the user attended for their personal music collection. This method of doing business provides artist, venue, and other licensing partner with proceeds otherwise lost to the bootleg recording industry, and provides the user with the immediate convenience of automatically receiving commemorative recordings of all music concerts he attends.

In some implementations, user preferences are at least partially determined and honed by developing and updating a unique user profile, with one of the goals of the development of the user profile being to provide content that would most likely be of interest to the user, and in a manner or timing which would be preferable to the user.

The user can actively enter preferences which are used to further enhance the user profile. In some implementations, users may be surveyed using a hybrid binary tree algorithmic method designed to gather desirable demographic and preference data from the user in the least amount of questions. The user may also be asked to enter in basic status and background information about themselves, including their age, gender, marital status, place of birth, and residence location, among other things. Depending on content interests, or executed transactions, users may also receive inquiries or provide ratings. For example, after attending an event in which tickets were purchased using the system 100, users may be asked to rate or comment on the venue, services, features and underlying attraction or performance.

Users also passively provide information which is processed and used to enhance the user profile along with the actively provided data. In some implementations, passively collected user data is obtained by tracking user interactions with the system 100 and their respective use of the user platform 102. In some implementations, the system 100 may be accessed and a transaction recorded in the user platform 102 and configured to detect certain user operations. For example, if a user purchases tickets to an event, the system 100 may record and compile information relating to the event, such as the type of event, artist, venue, genre, etc., and use this information, along with any existing user profile information, to further develop and enhance the user profile to better understand the user's preferences.

The user platform 102 itself, as well as user accounts with online music services (e.g., Pandora, Last.fm, Rhapsody, etc.) may be scanned to obtain information useful for the purpose of developing the user profile. For example, many user platforms, such as mobile phones, include music file playing functionality and it has become increasingly popular for users of such devices to maintain large collections of music files on these devices, or music collections and/or music preference information on their online music accounts. These collections can be scanned for information relating to the music files, such as the artist, type of music, relative amounts of different types of music, numbers of times each file has been played, user rankings/ratings of individual songs, and then processed by the system 100 to further develop the profile. Many user platforms are customizable with software features or downloadable applications, such as games, social networking programs, instant message or email services, which may also be detected and used by the system 100 for profile enhancement.

The compiled information whether provided by user submission, recorded from user activity or scanned without user intervention, may be compared with statistical correlation system, intelligent software prediction system, pattern recognition formulas or programs used for processing raw recorded user data to determine the most likely preferences in other areas of interest in addition to developing a comprehensive user profile. The continual collection and processing of information over time may be used to track general user preferences over time for comparable users, which may further assist the system 100 in developing profiles and predicting greater user trends and correlating interests for comparable users or groupings of users. Thus, in some implementations, content provision and recommendations based on specific user interests and/or correlations between user profiles may be directed to users accordingly through the user platform 102. In particular, transactions for items or services, such as tickets to an event occurring within a certain time and distance from the user, may be flagged as something of interest to the user based on the user profile and forwarded to the user platform 102. It should be readily apparent that response to such content may further impact the user profile and further content may be provided as a result. For example, the purchase of tickets to an event, and purchases of items or services during the event as provided by the venue or otherwise, may be used as an indicator of interest or taste, and thereafter used along with other information to enhance the intelligent prediction system of the invention.

In some implementations, the user experience is further enhanced by customizing content, and in particular, customizing prior user feedback to content so that users either view feedback from other users with similar specific preferences or generally comparable user profiles. For example, a user interested in purchasing a particular item or service may be provided with ratings only from other users falling within a certain range of similar tastes that have previously purchased the item or service, or even a similar item or service, or receive ratings along with an indication of which ratings are from users with similar interests, so that the interested user will be better able to ascertain how they might rate the event accordingly.

In some implementations, the system 100 includes a social networking component which allows users to communicate with one another via the user platforms, or automated connectivity through other popular social networking platforms. It should be readily apparent that the system 100 may facilitate communication between users of all kinds, including users having similar interests or generally comparable profiles, or even users having diametrically opposed user profiles. The use of taste profile filters, GPS location, attendance of same events, and other information specific the invention's platform, as the means or filter for selecting social networking opportunities, is a novel aspect of the invention platform.

In some implementations, the presentation of targeted information, potential transactions or other opportunities may be accomplished through “push” notifications sent to the user platform 102. Push notifications may be provided in scenarios discussed herein, such as, during attendance of a concert where offers of items or services for sale may be sent to users in connection with the underlying event or for other reasons based on the user's interest in the event. The system 100 may utilize push notifications in social networking context to encourage group participation. For example, upon purchasing a DIT relating to an event, the user may use the push notifications to send notification of the purchase to contacts or friends on any conventional social networking site which also is configured to facilitate the purchase of tickets, possibly for adjacent seats to the user, by the contact or friend. Alternatively, the same functionality may be provided through messages sent that contain executable software or hyperlinks to webpages for purchasing tickets or other items.

In some implementations, the user platform 102 and system 100 may be configured to continually determine the location of users (through the location of the user platform 102) relative to content, such as nearby events, services, amenities, activities, items for sale, etc., identify such content that may be of interest to the user, based on the user preferences and/or intelligent predictive system comparison of the particular content to the current user profile, and notify the user of such content, while also pointing out any time-sensitive content, such as the upcoming occurrence of a unique event, if applicable. The notification may be provided through push notification system to make it easier for the user to indicate a desire to participate, purchase or otherwise engage in the activity presented through the push notification.

As discussed above, the system 100 of the invention is not limited to any source for content, and may obtain content for transmission to users through a variety of sources. In some implementations, the procurement and aggregation of content to be presented to users regarding events, products and services available for a DIT-enabled purchase may include a variety of sources, some of which are described herein.

In one example, the system 100 of the invention may employ software data mining, in that software on the central server 110 “data mines” digital sources and compiles the event listings into a component of the system 100 (referred to hereinafter as “EventScout”), providing the central server 110 with a source of event listing information. This includes but is not limited to: ticket broker websites, regional event websites, exposed internet application programming interfaces (API's) for querying events, venue websites, social networking accounts/pages/API's for events, and so on.

In another example, the system 100 of the invention may employ human data mining, in that compiled information, via user interface, would be inputted directly into the EventScout database. This includes newspapers, chamber of commerce, magazines and publications, regional website surfing, use of other mobile apps that present event information, telephone calls to venues, use of social networking pages, etc.

In yet another example, the system 100 of the invention may employ user event entry. Users often know about smaller and lesser events that are not advertised or well known (such as a local cribbage championship or poetry gathering), and are thus provided an interface via the user platform 102 for entering their own events for potential dissemination to targeted users.

In yet another example, content suppliers, such as venues, stores, private sellers, service providers, online and printed publications and the like, may engage in a relationship with one or more proprietors of individual components of the system 100 or otherwise be provided with the ability to post or input content on the system 100. In some implementations, the system 100 is configured to also automatically post such content in multiple marketing locations or sites where potential interested customers may view the listing, thus avoiding the time-consuming inconvenience of placing duplicating listings in multiple locations. For example, a venue may access a user interface provided for venue content suppliers which is configured to receive key event information, such as artist information, time, date, promotional description, photos, video/music samples, etc., which will be saved in the central server 110 and forwarded to targeted users via user platforms as well as posted to sources such as social networking sites and services (e.g., “Facebook,” “Twitter,” or “mySpace”), online and printed publications and events listings websites, among other things. It thereby provides value to the venue in marketing the event more easily, while also providing the central server 110 with event listing information. Furthermore, it allows suppliers to manage their inventory and operations via a standardized protocol for inspection, analytics and transaction, referred to herein as “OpenTicket.” For example, a venue may utilize the central server 110 to conduct a query through a content supplier interface with the system 100, all OpenTicket users to determine information on upcoming events.

In some implementations, the central server 110 is configured to act as agent for logging into a user's social networking accounts, on behalf of them, to gather information on their contacts, such as which of their friends are already going to events (RSVP), which of their friends have notified them of events, and to, via these agent actions, propagate further notifications through other social networks about their own attendance of events, knowledge of events, intent to attend future events, and so on. Information regarding the user's contacts or social networking page may also be collected to enhance the user taste profile and predictive system.

Users may also enter their own events into EventScout but categorize the event as private (such as a house party, etc.), and then publicize the private event to other users who are listed as contacts or friends or otherwise included in the user's social network, whether through alert/notification, and/or inclusion of private events on the list of events that are displayed to their friends using the platform, and/or automatically propagating the private event through the user's other social networking accounts. Users may also host or organize private parties and send out social networking alerts (via text, email, push notification), invites, information, news, etc., to unknown users of the network based on filters such as having overall comparable tastes, GPS location, sharing comparable tastes in certain things, etc., as provided by the user profiles and predictive system of the invention.

In some implementations, the system 100 is configured to enable users to interact with a checklist of friends in their social network (or others based on profile, GPS location, etc.) to alert/invite to a private hosted event, then also have that event in the event listings show up any time those users interact with the platform; organize social networked friends into user defined categorical social groups such as business, family, best friends, lesser friends, acquaintances, friends of friends, and so on; set up exclusionary relationships where a pair of friends are flagged for not being invited to the same event (and if they both are, whoever first responds or RSVP's will trigger an event erasing the event from being viewable by the other); and, instead of the effort of going through a checklist individually, select to invite mass groups and exclude other mass groups based on group checklists.

It should be readily apparent that transaction, whether private or otherwise, may be facilitated with a DIT. The DIT may also execute one or more queries to the user before/during/after the event, soliciting the user's opinion, ranking, comments, etc. The queries may not be limited to the subject of the transaction. For example, if the transaction relates to an event, the queries may also relate to individual acts, artists, the venue, and so on. Certain user controls can provide further information to the user profile information, such as controls allowing 5-star rankings, thumbs-up thumbs-down, and so on.

As discussed above, in some implementations, the presentation of content, such as a listing of events, products or services in a menu, is ranked according to the intelligent software prediction system's determination that the characteristics of the content (e.g., event product or service) either matches features of the user's taste profile within a desired degree of probability or possesses a sufficient likelihood of being of interest to the user as predicted based on the user's taste profile. The system 100 may be configured to also provide weighted rankings of content (such as for example, a ranking of from 1 to 5 stars), that is, rankings which are displayed to the requesting user based on the intelligent software prediction system's weighting of user votes according to the relative similarity between voting users and the requesting user, as determined by a comparison of respective taste profiles. For example, a first user's vote or ranking of content having a similar profile to the user assessing the content may be counted as a greater amount of votes as compared to a second user's vote or ranking if that second user's profile is less similar to the assessor than the profile of the first user, as determined based on pattern recognition intelligence incorporated in the system 100 of the invention.

It should be readily apparent that ratings or comments which have been submitted from voters having similar tastes to the user are more likely to be of greater helpful value to a user who is considering options or in reaching a decision. In some implementations, the system 100 of the invention incorporates recommendations based on knowledge prediction, sophisticated statistical correlation, and pattern recognition algorithms to generate intelligent recommendations, and utilizes this functionality to provide a personalized rating system, rather than a universal one-rating-fits-all “democratic” rating system. Thus, the process of assessing input from voters can be adjusted in accordance with the relative taste similarities, either overall or in one or more specific areas, between each respective voter to the user who is interested in receiving a personalized rating.

In providing the system 100 as described herein, the system 100 of the invention is configured and adapted to interact with users in such a way that each interaction is detected and analyzed to enhance the user taste profile and predictive system. For example, interactions which may affect the user profile may include interactions: via the user-interface supplying a method of immediately providing rankings, checkboxes with thumbs-up/thumbs-down, etc; via finger gestures (or other user interface controls) which slide an event higher on the list or lower on the list as an indicator of greater or lesser interest/taste matching; via the mere fact that a user selects an event to look at it for more information, being an indicator that there is some higher degree of interest for such an event; via a finger gesture (or other user interface control) which allows the user to slide an event right out of the list because it is a bad match to his taste; via user interface components which allow an indecisive user to indicate he may in the future be interested in going to this event or a future recurrence of similar events by the same artist (or at the same venue); via the user being able to rate the venue while looking at detail information on the event (or detail information on the venue which is can be triggered when looking at detail information on the event); via the mere fact that the user interacts with social networking options which are presented in detail information about the event, such as invitations, etc.; via the fact that the user considered purchasing a ticket (but may or may not have consummated the purchase); via the GPS location of the user's location when using the application, providing insight into the activities and interests of the user (such as if the user is located in an amusement park, certain business, restaurant, nightclub, or boutiques, etc.), or identified by the system 100 as being in attendance at a particular event taking place at that time/location while accessing the system 100 through the user platform 102.

In the implementation of FIG. 1, the transaction server 106 provides services to the Core Platform Processes, upon the CPP retrieving information from the Ticket Procurement Application on available seats, to transact the purchase of tickets from the venue, or intermediary (e.g. ticket broker). The Core Platform Processes represents a “middle tier” server layer in the client/server architecture depicted in FIG. 1, in that it performs all the business application logic and mediates between the database layer and its stored data, and the client layer which makes requests of the middle tier for it to organize, structure, and deliver data according to the provided filters supplied by its requests.

The central server 110 and/or other components of the system 100 may include a TasteTrak Application. The TasteTrak Application semi-autonomously resides within the CPP. This server application component accesses all pertinent information about artists, events, venues, and user tastes, and implements artificial intelligence, pattern recognition, statistical correlation methodologies, and knowledge prediction system 100, in order to help the CPP filter requests from users in order to supply them information about the venues, artists, and events: specifically, “taste match rankings” (one-dimensional value whose magnitude from low to high represents low taste match to high taste match, respectively).

The central server 110 and/or other components of the system 100 may include a Client Server Communications Layer. The Client Server Communications Layer provides various API's, methods, services and interfaces to the numerous client types with their various formats and protocols, of the type which will be making requests of the server. This layer's job includes translating these into a single standardized format to pass on to the Core Platform Processes, and likewise, obtaining communications from CPP and translate them back into the various formats expected of the diverse client types.

The central server 110 and/or other components of the system 100 may include an EventScout Aggregator Application. The EventScout Aggregator Application is a server-side master application (composite application) which includes a system 100 of sub-applications which aggregate information from the wide diversity of sources for receiving event information, that have been specified elsewhere. It is responsible for obtaining all the key event information that goes into the databases of the server-side data layer.

The central server 110 and/or other components of the system 100 may include a Venue Event Publication Application. The Venue Event Publication Application is an application provided to venues, which includes a web portal and/or web application. It enables venues that currently have to redundantly replicate marketing efforts for events through multiple channels (e.g., “Facebook,” “mySpace,” local events websites, newspapers, etc.), with a single interface from which they can post their event information once, and which then gets posted across multiple channels automatically upon submission. In this implementation, one of the channels is the Event Scout system 100. This free service may be provided in exchange for marketing concessions such as the venue accepting the use of the DIT, VIP status for digital interactive ticket customers (e.g., not forcing DIT customers to wait in line with other customers who are waiting simply to pay for a ticket the DIT customer has already purchased), door and window decal marketing, and indoor poster marketing. One of the key aspects is that this feature is a marketing tool to give venues a valuable service for free, accept concessions that are essentially at no cost to them (indeed, these features provide extra functionality and prestige to the venue), yet also create a network for the system 100 of the invention to gather more complete event listings than any other service, and, use the system 100's DIT revenue model directly with the venue.

Those skilled in the art will recognize that the concepts, structures, system 100, and methods of this disclosure may be implemented in many manners and as such this disclosure is not to be limited by the exemplary implementations and examples set forth herein. In other words, functional elements may be performed by a single or multiple components, by various combinations of hardware and software or firmware, or both. In this regard, any number of the features of the different implementations described herein may be combined into single or multiple implementations, and alternate implementations having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein.

Moreover, the scope of the present disclosure covers conventionally known manners for carrying out the described features and functions and interfaces, and those variations and modifications that may be made to the hardware or software or firmware components described herein as would be understood by those skilled in the art now and hereafter. Numerous other changes may be made which will readily suggest themselves to those skilled in the art and which are encompassed in the spirit of this disclosure. It is to be understood that modifications and variations may be utilized without departure from the spirit and scope of the system 100 of the present invention, as those skilled in the art will readily understand. Such modifications and variations are considered to be within the purview and scope of the appended claims and their equivalents.

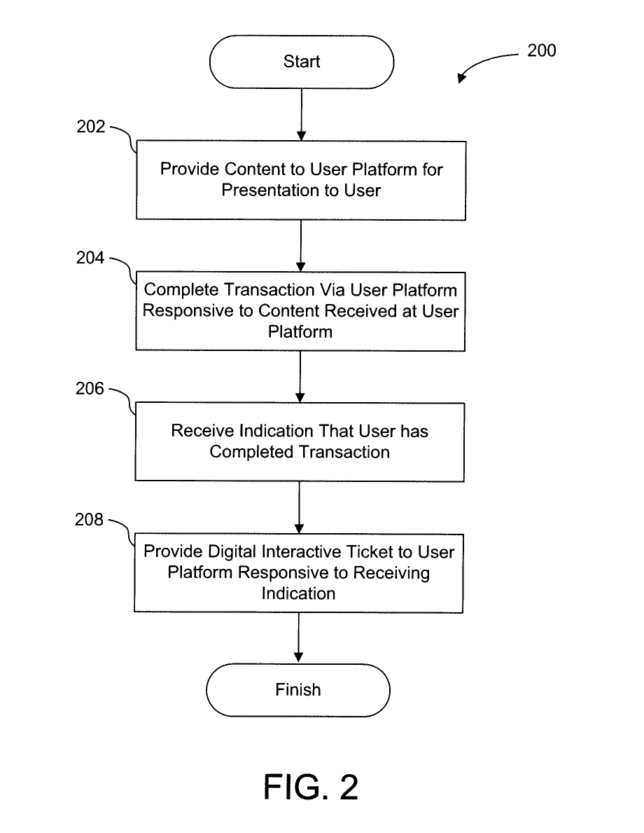

FIG. 2 is a flowchart illustrating a method 200 for facilitating completion of obligations associated with transactions performed via mobile user platforms based on digital interactive tickets associated with a unique geographical location and/or user preferences, in accordance with one or more implementations. The operations of the method 200 presented below are intended to be illustrative. In some implementations, the method 200 may be accomplished with one or more additional operations not described, and/or without one or more of the operations discussed. Additionally, the order in which the operations of the method 200 are illustrated in FIG. 2 and described below is not intended to be limiting.

In some implementations, the method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 200 in response to instructions stored electronically on an electronic storage medium. The one or more processing devices may include one or more devices configured through hardware, firmware, and/or software to be specifically designed for execution of one or more of the operations of the method 200.

At operation 202, content may be provided to a user platform for presentation to a user of the user platform. The content may be provided based on a geographical location of the user platform and/or a user preference associated with the user. The content may include information associated with the geographical location of the user platform. Operation 202 may be performed by the central server 110, the external resources 108, the vendor platform 104, and/or other components of the system 100.

At operation 204, a transaction may be completed by the user via the user platform responsive to the content received at the user platform. Operation 204 may be performed in conjunction with the user platform 102 and/or other components of the system 100.

At operation 206, an indication may be received that the user has completed the transaction via the user platform. Operation 206 may be performed by the central server 110 and/or other components of the system 100.

At operation 208, a digital interactive ticket may be provided to the user platform responsive to receiving the indication. The digital interactive ticket may include executable software and/or requisite data enabling the digital interactive ticket to provide additional functionality on the user platform. The additional functionality may facilitate completion of one or more obligations associated with the completed transaction. Operation 208 may be performed by the central server 110 and/or other components of the system 100.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A method for facilitating completion of obligations associated with transactions performed via mobile user platforms based on digital interactive tickets associated with a unique geographical location and/or user preferences, the method comprising:
receiving an indication that a user has completed a transaction presented to the user via a user platform, the transaction being completed responsive to content received at the user platform, the content being provided to the user platform based on a geographical location of the user platform and/or a user preference associated with the user, the content including information associated with the geographical location of the user platform; and
providing a digital interactive ticket to the user platform responsive to receiving the indication, the digital interactive ticket including executable software and/or requisite data enabling the digital interactive ticket to provide additional functionality on the user platform, the additional functionality facilitating completion of one or more obligations associated with the completed transaction.

2. The method of claim 1, wherein the additional functionality provided to the user platform by the digital interactive ticket enables the user to select reminder notifications and/or delivery options associated with the digital interactive ticket.

3. The method of claim 1, wherein the content includes information related to one or more of transaction data, an advertisement, news, information of interest to the user, a sale, an auction, an offer for an item, an offer for a service, an opportunity to participate in an event, or an opportunity to attend an event and/or a venue.

4. The method of claim 1, wherein the digital interactive ticket is configured to function as one or more of (1) a receipt in connection with a transaction and/or payment of a charge, (2) an acknowledgement and/or proof of a matter unassociated with a payment, or (3) a receipt for a purchase of an entry ticket.

5. The method of claim 1, wherein the digital interactive ticket is configured to enable payment of a charge associated with an event and/or venue responsive to content including information associated with the event and/or venue being communicated to the user via the user platform based on one or more of (1) a proximity of the user platform to the event and/or venue, (2) a prediction of the user's tastes and/or preferences, or (3) a delivery of event information that matches the user's time, location, and/or event genre preferences.

6. The method of claim 1, wherein the digital interactive ticket is configured to include a super-redundant redemption mechanism, the super-redundant redemption mechanism being configured to overcome incompatibility issues due to a form of a transaction receipt.

7. The method of claim 1, wherein the digital interactive ticket is configured to include a hyperlink, the hyperlink being activated responsive to one or more of receipt of the digital interactive ticket by the user platform, redemption of the digital interactive ticket by the user, or detection of the user platform being in a predetermined geographical location.

8. The method of claim 1, wherein the digital interactive ticket is configured to include a ticket identification number.

9. The method of claim 1, wherein the digital interactive ticket is configured to include an activated redemption graphic, the activated redemption graphic configured to facilitate security of the transaction completion and/or to assure counterfeit prevention.

10. The method of claim 1, wherein the digital interactive ticket is configured to represent and/or replace a paper ticket for admission to an event and/or venue.

11. The method of claim 1, wherein the digital interactive ticket is configured to provide, to the user platform, navigation directions to an event and/or venue associated with the digital interactive ticket.

12. The method of claim 1, wherein the digital interactive ticket is configured to distinguish the user as a VIP and/or recipient of exclusive services.

13. The method of claim 1, wherein the digital interactive ticket is configured to facilitate transfer of the digital interactive ticket and/or redemption of the digital interactive ticket responsive to a user gesture or a user input received by the user platform.

14. The method of claim 1, wherein the digital interactive ticket is configured to be used as a boarding pass and/or for hotel check-in.

15. The method of claim 1, further comprising providing, for presentation to the user, a copy of a redeemed digital interactive ticket to the user platform.

16. The method of claim 1, wherein one or more of the user preferences are determined based on a collection of music associated with the user.

17. The method of claim 1, wherein one or more of the user preferences are determined based on one or more user interactions with the user platform.

18. The method of claim 1, wherein the digital interactive ticket facilitates an entity-place-possession-device nexus such that the digital interactive ticket is possessed by only one given person and exists only at one time at one geo-location on one device.

19. The method of claim 18, wherein the digital interactive ticket cannot be redeemed if the entity-place-possession-device nexus is not satisfied.

20. The method of claim 18, wherein the digital interactive ticket facilitates associated with the entity-place-possession-device nexus is auctionable by the one given person.

21. The method of claim 1, further comprising providing a notification to a first user that a second user would like to acquire the digital interactive ticket.

22. A system configured to facilitate completion of obligations associated with transactions performed via mobile user platforms based on digital interactive tickets associated with a unique geographical location and/or user preferences, the system comprising:
one or more processors configured to execute one or more computer program modules, execution of the one or more computer program modules causing the one or more processors to:
receive an indication that a user has completed a transaction presented to the user via a user platform, the transaction being completed responsive to content received at the user platform, the content being provided to the user platform based on a geographical location of the user platform and/or a user preference associated with the user, the content including information associated with the geographical location of the user platform; and
provide a digital interactive ticket to the user platform responsive to receiving the indication, the digital interactive ticket including executable software and/or requisite data enabling the digital interactive ticket to provide additional functionality on the user platform, the additional functionality facilitating completion of one or more obligations associated with the completed transaction.

23. A computer-readable storage medium having instructions embodied thereon, the instructions being executable by a processor to perform a method for facilitating completion of obligations associated with transactions performed via mobile user platforms based on digital interactive tickets associated with a unique geographical location and/or user preferences, the method comprising:
receiving an indication that a user has completed a transaction presented to the user via a user platform, the transaction being completed responsive to content received at the user platform, the content being provided to the user platform based on a geographical location of the user platform and/or a user preference associated with the user, the content including information associated with the geographical location of the user platform; and
providing a digital interactive ticket to the user platform responsive to receiving the indication, the digital interactive ticket including executable software and/or requisite data enabling the digital interactive ticket to provide additional functionality on the user platform, the additional functionality facilitating completion of one or more obligations associated with the completed transaction.
